(19) United States
(12) Patent Application Publication
(10) Pub. No.: US 2008/0185089 A1
(43) Pub. Date: Aug. 7, 2008

(54) SYSTEM AND METHOD FOR PATCHING POOL LINER

(76) Inventor: Robert T. WILLCOTT, Overland Park, KS (US)

Correspondence Address: SPENCER, FANE, BRITT & BROWNE, 1000 WALNUT STREET, SUITE 1400, KANSAS CITY, MO, 64106-2140, US

(21) Appl. No.: 11/670,541

(22) Filed: Feb. 2, 2007

(51) Int. Cl. B32B 43/00; B32B 7/12

(52) U.S. Cl. 156/94; 428/354

(57) ABSTRACT

A system and method for repairing tears or holes in sheets of materials. Where the material is a vinyl pool liner, making a repair below the water line can be accomplished without draining the pool to expose the hole and then refilling the pool once the repair is complete. The system comprises an adhesive and a mastic pad. The mastic pad includes a backing material and a mastic compound applied to an inward side of the backing material. The adhesive at least assists in adhering the mastic pad to the material. Where the material is vinyl, the backing material may be flexible all-weather polyvinyl chloride and the mastic compound may be a rubber-based mastic compound laminated to the backing material. Other materials which may be repaired using the present invention, and/or other backing materials which may be used to do so, include canvas, nylon, plastic, and rubber.

### FIELD OF THE INVENTION

The present invention relates to systems and method for patching or otherwise repairing tears and holes in sheets of materials. More specifically, the present invention concerns a system and method for patching or otherwise repairing tears or holes in sheets of materials, such as vinyl pool liners, using an appropriate adhesive, such as a vinyl adhesive, and a mastic pad including an appropriate backing material, such as vinyl, and a mastic compound.

### BACKGROUND OF THE INVENTION

It is often desirable to repair tears or holes in sheets of materials. For example, in swimming pools and the like having synthetic, e.g., vinyl, liners, it sometimes happens that stresses at certain points cause tears or holes to develop in the liners. Patch kits are available for patching such holes using a vinyl adhesive and a swatch of vinyl. Unfortunately, these kits suffer from a number of problems and disadvantages. For example, they generally cannot be applied underwater, which means that the pool must be drained, at least past the point of repair, and then refilled once the repair is complete.

### SUMMARY OF THE INVENTION

The system and method of the present invention allows for patching or otherwise repairing tears or holes in sheets of materials under a variety of repair and use conditions. For example, where the sheet of material is a vinyl pool liner, the present invention advantageously allows for repairing a tear or hole that is below the pool's water line without requiring that the pool be drained, at least past the point of repair, and then refilled once the repair is complete.

In one embodiment, the system comprises an adhesive and a mastic pad, with the mastic pad including a backing material having an inward side and an outward side, and a mastic compound applied to the inward side, and wherein the adhesive at least assists in adhering the mastic pad to the material. As mentioned, for example, where the sheet of material is vinyl, the adhesive may be a vinyl adhesive and the backing material may be vinyl. More specifically, the backing material may be flexible all-weather polyvinyl chloride and the mastic compound may be a rubber-based mastic compound laminated to the backing material. The mastic pad may have an inherent adhesiveness which increases as the mastic pad warms and softens. Other materials which may be repaired using the present invention, and/or other backing materials which may be used to do so, include canvas, nylon, plastic, and rubber.

These and other features of the present invention are described in greater detail below in the section titled DETAILED DESCRIPTION.

### BRIEF DESCRIPTION OF THE DRAWING FIGURES

The present invention is described herein with reference to the following drawing figures:

FIG. 1 is a fragmentary elevation view of an embodiment of the system being used to repair a hole in a sheet of material; and

FIG. 2 is a cross-sectional view of the system shown in FIG. 1.

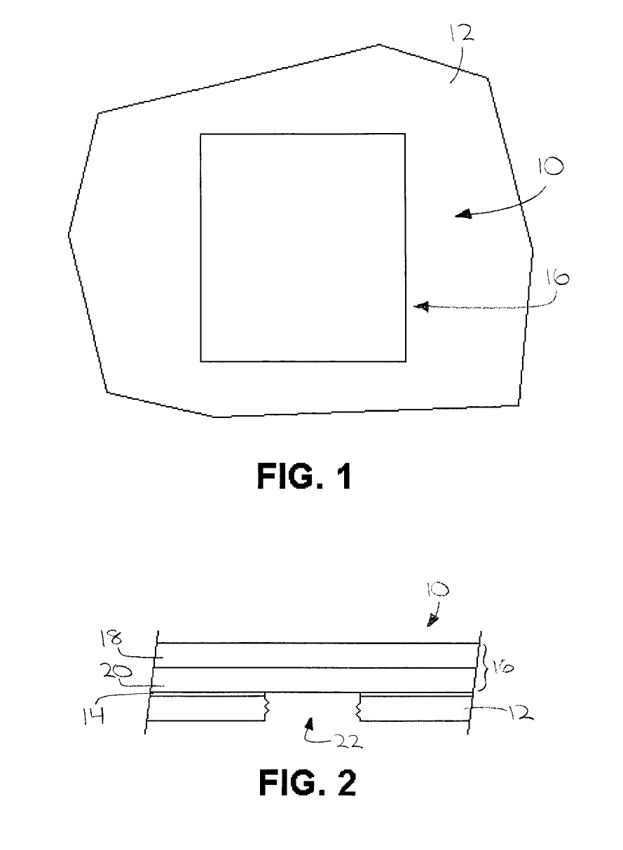

The figures, and individual components shown therein, are not necessarily drawn to scale; greater emphasis has been placed on clarity.

### DETAILED DESCRIPTION

With reference to the figures, a system 10 and method is herein described, shown, and otherwise disclosed in accordance with a preferred embodiment of the present invention. Broadly, the system 10 and method allow for patching or otherwise repairing tears or holes in sheets of materials 12. Though described herein in the context of patching or repairing vinyl, particularly vinyl pool liners, the system 10 and method may be used on or with other natural or synthetic materials such as canvas, nylon, plastic, and rubber.

In one embodiment, the system 10 comprises an adhesive 14 and a mastic pad 16. The adhesive 14 adheres, or at least assists in adhering, the mastic pad 16 to the sheet of material 12 being patched or repaired. The properties of the adhesive 14 may depend upon both the type of material 12 and the conditions under which the repair may take place and/or under which the material 12 may be used. For example, where the material 12 is a vinyl pool liner, and the repair may be exposed to significant amounts of water or even located underwater and/or may be exposed to significant changes in temperature and significant amounts of ultraviolet radiation, the adhesive 14 is preferably a vinyl adhesive that does not weaken or otherwise degrade significantly under those conditions. As mentioned, the adhesive 14 may provide all of the adhesiveness, or may merely supplement the inherent adhesiveness of the mastic pad 16.

The mastic pad 16 includes an appropriate backing material 18 having an inward side and an outward side, and a mastic compound 20 applied to the inward side. The mastic pad 16 provides physical structure for covering the tear or hole, and, as mentioned, may provide some adhesiveness for adhering, or assisting in adhering, itself to the sheet of material 12 being patched or repaired. The properties of the mastic pad 16, particularly the backing material 18 and the mastic compound 20, may depend upon both the type of material 12 and the conditions under which the repair may take place and/or under which the material 12 may be used. For example, where the material 12 is a vinyl pool liner, and the repair may be exposed to significant amounts of water or even located underwater and/or may be exposed to significant changes in temperature and significant amounts of ultraviolet radiation, the backing material 18 is preferably vinyl and the mastic compound 20 is such as to not weaken or otherwise degrade significantly under those conditions.

One available mastic pad generally suitable for use as the mastic pad 16 of the present invention is the Scotch™ 2200 Vinyl Mastic Pad, sold by 3M Company, which combines moisture-sealing mastic with a vinyl backing. More specifically, the product includes a self-fusing, rubber-based mastic compound laminated to a flexible, all-weather polyvinyl chloride (PVC) backing. The product has some inherent adhesiveness of its own, which increases as the product warms and softens. The product is normally used in electrical applications, such as for electrically-insulating, moisture-sealing, and padding connections on electrical cables rated up to 600 volts, and especially for inline 3-way, 4-way tee and wye splices, motor leads, bus bars, lighting systems, switchgears, and terminal spades. The product is normally colored black, but could be colored blue and/or other appropriate colors which more closely match the material 12 being repaired.

By way of first example and not limitation, an embodiment of the system 10 may be used and may function as follows. Referring particularly to FIG. 2, given a sheet of material 12 having a hole 22 in need of repair, the adhesive 14 is applied, either directly to the material 12 around the hole 22 or to the mastic pad 16, and the mastic pad 16 is applied over the hole 22 with the outward side of the backing material 18 facing outward.

By way of second example and not limitation, an embodiment of the system 10 may be used and may function as follows. Referring still to FIG. 2, given a vinyl pool liner 12 having a hole 22 in need of repair below the pool's water line, without draining any water from the pool the vinyl adhesive 14 is applied, either directly to the vinyl pool liner 12 around the hole 22 or to the mastic pad 16, and the mastic pad 16 is applied over the hole 22 with the outward side of the vinyl backing material 18 facing outward.

From the preceding discussion, it will be appreciated that the present invention overcomes problems and limitations in the prior art by allowing for patching or otherwise repairing tears or holes in sheets of materials under a variety of repair and use conditions. For example, where the sheet of material is a vinyl pool liner, the system 10 advantageously allows for repairing a tear or hole that is below the pool's water line without requiring that the pool be drained at least past the point of the repair and then refilled once the repair is complete.

Although the invention has been described with reference to various embodiments, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A system for repairing a sheet of material, the system comprising:
an adhesive; and
a mastic pad including—
a backing material having an inward side and an outward side, and
a mastic compound applied to the inward side,
wherein the adhesive at least assists in adhering the mastic pad to the material.

2. The system as set forth in claim 1, wherein the sheet of material is vinyl, the adhesive is a vinyl adhesive, and the backing material is vinyl.

3. The system as set forth in claim 2, wherein the backing material is flexible all-weather polyvinyl chloride.

4. The system as set forth in claim 2, wherein the mastic compound is a rubber-based mastic compound laminated to the backing material.

5. The system as set forth in claim 4, wherein the rubber-based mastic compound is self-fusing, electrically-insulating, and moisture-sealing.

6. The system as set forth in claim 1, wherein the mastic pad has an inherent adhesiveness which increases as the mastic pad warms and softens.

7. The system as set forth in claim 1, wherein the backing material is selected from the group consisting of canvas, nylon, plastic, and rubber.

8. A system for repairing a sheet of vinyl, the system comprising:
a vinyl adhesive; and
a mastic pad including—
a polyvinyl backing material having an inward side and an outward side, and
a rubber-based mastic compound laminated to the inward side, wherein the vinyl adhesive at least assists in adhering the mastic pad to the sheet of vinyl.

9. A method of repairing a sheet of material, which comprises the step of using an adhesive to at least assist in adhering a patch over a tear or hole in the sheet of material, the patch comprising—
a mastic pad including a backing material having an inward side and an outward side, and a mastic compound applied to the inward side.

10. The method as set forth in claim 9, wherein the sheet of material is vinyl and the backing material is vinyl.

11. The method as set forth in claim 10, wherein the backing material is flexible all-weather polyvinyl chloride.

12. The method as set forth in claim 10, wherein the mastic compound is a rubber-based mastic compound laminated to the backing material.

13. The method as set forth in claim 12, wherein the rubber-based mastic compound is self-fusing, electrically-insulating, and moisture-sealing.

14. The method as set forth in claim 10, wherein the mastic pad has an inherent adhesiveness which increases as the mastic pad warms and softens.

15. The method as set forth in claim 10, wherein the backing material is selected from the group consisting of canvas, nylon, plastic, and rubber.

16. In a system for repairing a sheet of material, the system including a patch for application over a tear or hole in the sheet of material, and an adhesive for at least assisting in adhering the patch to the sheet of material, the improvement comprising—
the patch being a mastic pad including a backing material having an inward side and an outward side, and a mastic compound applied to the inward side.

17. The system as set forth in claim 16, wherein the sheet of material is vinyl and the backing material is vinyl.

18. The system as set forth in claim 16, wherein the backing material is flexible all-weather polyvinyl chloride.

19. The system as set forth in claim 16, wherein the mastic compound is a rubber-based mastic compound laminated to the backing material.

20. The system as set forth in claim 19, wherein the rubber-based mastic compound is self-fusing, electrically-insulating, and moisture-sealing.

21. The system as set forth in claim 16, wherein the mastic pad has an inherent adhesiveness which increases as the mastic pad warms and softens.

22. The system as set forth in claim 16, wherein the backing material is selected from the group consisting of canvas, nylon, plastic, and rubber.
